(19) United States
(12) Patent Application Publication
(10) Pub. No.: US 2016/0006989 A1
(43) Pub. Date: Jan. 7, 2016

(54) SURVEILLANCE SYSTEMS AND METHODS THEREOF

(71) Applicant: Brandon S. Swanson, Sunnyvale, CA (US)

(72) Inventor: Brandon S. Swanson, Sunnyvale, CA (US)

(21) Appl. No.: 14/207,307

(22) Filed: Mar. 12, 2014

(51) Int. Cl. H04N 7/18; H04L 29/06

(52) U.S. Cl. CPC H04N 7/183; H04L 65/608; H04N 7/186; H04W 88/08

(57) ABSTRACT

Surveillance systems and methods for detecting unauthorized access are provided. A network device having one or more cameras integrated therein is provided. The network device may incorporate one or more physical connections to provide mechanical and/or electrical connections to one or more additional cameras. In accordance with an embodiment of the present invention, the cameras are cosmetically undetectable on a surface of the network device. Therefore, the cameras are less likely to be vandalized.

### CROSS-REFERENCE TO RELATED APPLICATIONS

This application claims the benefit of U.S. Provisional Application No. 61/780,516, filed Mar. 13, 2013, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2013-2014 Fortinet, Inc.

### BACKGROUND

1. Field

Embodiments of the present invention generally relate to surveillance cameras and network devices. More specifically, embodiments of the present invention relate to surveillance systems that include one or more network devices having one or more cameras integrated therein. Further, embodiments of the present invention relate to methods of using the aforesaid surveillance systems.

2. Description of the Related Art

Today, many organizations, such as enterprises, universities and government agencies, have a need for a wireless network in addition or as an alternative to a wired network. This need has only increased in recent times, as wireless networks provide flexibility to their users and are easier to set up and use. In order to setup a wireless network within an organization, multiple wireless Access Points (APs) need to be installed at suitable locations within premises of the organization.

However, wireless networks are more vulnerable to intrusion by unauthorized users as compared to wired networks. For example, an unauthorized user may set up an unauthorized AP (hereinafter referred to as a ‘rogue AP’) within the organization, in order to access sensitive data and/or to forge communications between authorized users.

A conventional technique for detecting unauthorized physical access involves using surveillance cameras for monitoring activities within and/or near the premises of the organization. However, this conventional technique suffers from one or more disadvantages. Firstly, multiple surveillance cameras need to be installed at suitable locations within and/or near the premises of the organization. Secondly, separate power cables and Ethernet cables need to be provided to these surveillance cameras. Thirdly, installation of these surveillance cameras is time-consuming and expensive.

### SUMMARY

Surveillance systems and methods for detecting unauthorized access are described. In one aspect, embodiments of the present invention provide a network device having one or more cameras integrated therein. In accordance with an embodiment of the present invention, the cameras are cosmetically undetectable on a surface of the network device. Therefore, the cameras are less likely to be vandalized.

In accordance with an embodiment of the present invention, the network device incorporates one or more physical connections to provide mechanical and/or electrical connections to one or more additional cameras.

Examples of the network device include, though are not limited to, a wireless Access Point (AP), a modem, a router, a network switch, a network gateway and a firewall. Beneficially, the network device may be implemented as a wireless AP.

In another aspect, embodiments of the present invention provide a surveillance system that includes one or more network devices having one or more cameras integrated therewith. The network devices are provided with software and/or hardware that enable the network devices to integrate with the cameras. Hence, separate power cables and Ethernet cables need not be provided to these cameras. This facilitates significant reduction in cost and time required to set up the surveillance system.

The surveillance system also includes a control arrangement for controlling the cameras to monitor activities of unauthorized users within and/or near premises of an organization. The control arrangement is coupled to the network devices and/or the cameras via a communication network.

In accordance with an embodiment of the present invention, the surveillance system is operable to detect an unauthorized AP spatially located within and/or near the premises (hereinafter referred to as a ‘rogue AP’). The control arrangement may then be operable to determine a spatial location of the rogue AP, for example, by way of triangulation. Subsequently, the control arrangement may be operable to map the spatial location of the rogue AP to at least one camera spatially located in a proximity of the rogue AP. Consequently, the control arrangement may be operable to send a trigger request to the at least one camera to record activity and/or notify a system administrator.

In accordance with an embodiment of the present invention, the control arrangement is operable to configure the cameras to track one or more users connected to their respective network devices.

In accordance with an embodiment of the present invention, the surveillance system is operable to configure the cameras to detect motion, and to record activity and/or notify the system administrator when motion is detected. For example, the cameras may be configured to detect motion, based on their spatial location.

In accordance with an embodiment of the present invention, the surveillance system is operable to couple the cameras to one or more entrance and/or exit doors within one or more zones of the premises, for detecting when one or more users enter and/or exit these zones. Accordingly, the cameras may be configured to record activity and/or notify the system administrator when the users enter and/or exit the zones.

Moreover, the cameras may be operable to record activity, and to stream recorded multimedia to the control arrangement on a real-time basis. Optionally, the recorded multimedia may be stored in a database that may be spatially remote from the surveillance system.

Additionally or alternatively, the surveillance system may include a video recorder that may be operable to store the recorded multimedia. The video recorder may either be a part of the control arrangement or be a separate device coupled to the control arrangement.

Embodiments of the present invention substantially eliminate the aforementioned problems in the prior art, and facilitate significant reduction in cost and time required to set up the surveillance system.

Additional aspects, advantages and features of embodiments of the present invention will be apparent from the accompanying drawings and the detailed description that follows.

It will be appreciated that features of embodiments of the present invention are susceptible to being combined in various combinations without departing from the scope of the present invention as defined by the appended claims.

### BRIEF DESCRIPTION OF THE DRAWINGS

The summary above, as well as the following detailed description of embodiments of the present invention, is better understood when read in conjunction with the accompanying drawings. For the purpose of illustrating embodiments of the present invention, exemplary constructions of the present disclosure are shown in the drawings. However, embodiments of the present invention are not limited to specific methods and instrumentalities disclosed herein. Moreover, those skilled in the art will understand that the drawings are not to scale. Wherever possible, like elements have been indicated by identical reference numerals.

Embodiments of the present invention are illustrated by way of example, and not by way of limitation, in the figures of the accompanying drawings and in which:

FIG. 1 is an illustration of an example premises in which a surveillance system may be employed pursuant to embodiments of the present invention.

FIG. 2 is a block diagram conceptually illustrating a network environment in which the surveillance system is implemented, in accordance with an embodiment of the present invention.

FIG. 3 is a block diagram conceptually illustrating interaction among various functional units of a camera provided with a network device, in accordance with an embodiment of the present invention.

FIG. 4 is a block diagram conceptually illustrating interaction among various functional units of a camera provided with a network device, in accordance with another embodiment of the present invention.

FIG. 5 is a flow diagram illustrating unauthorized access detection processing, in accordance with an embodiment of the present invention.

FIG. 6 is a flow diagram illustrating intrusion detection processing, in accordance with an embodiment of the present invention.

FIG. 7 is an exemplary computer system in which or with which embodiments of the present invention may be utilized.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

Surveillance systems and methods for detecting unauthorized access are described. Due to inherent vulnerabilities of wireless networks, it is desirable to detect unauthorized access to the wireless networks and take appropriate actions to prevent unauthorized access.

In light of the disadvantages of known conventional techniques described in the Background and the foregoing discussion, there is a need for a surveillance system that can be installed easily, and whose various components are capable of functioning synergistically to detect unauthorized access.

According to an embodiment of the present invention, a surveillance system includes one or more network devices that include one or more cameras integrated therewith. The network devices are provided with software and/or hardware that enable the network devices to integrate with the cameras. Hence, separate power cables and Ethernet cables need not be provided to these cameras. This facilitates significant reduction in cost and time required to set up the surveillance system.

Beneficially, the cameras may be cosmetically undetectable on surfaces of the network devices. Therefore, the cameras are less likely to be vandalized.

In addition, the surveillance system includes a control arrangement coupled to the network devices and/or the cameras via a communication network. The control arrangement is operable to control the cameras to monitor activities of unauthorized users.

In accordance with an embodiment of the present invention, the control arrangement is operable to determine a spatial location of a rogue Access Point (AP), and map the spatial location to at least one camera from amongst the cameras that is spatially located in proximity to the rogue AP. The spatial location of the rogue AP may, for example, be determined by way of triangulation. Subsequently, the control arrangement may then be operable to send a trigger request to the at least one camera to monitor activities of unauthorized users, who may be associated with the rogue AP.

Moreover, the control arrangement may be operable to configure the cameras to track specific users connected to their respective network devices. In this manner, each camera may be made responsible for detecting unauthorized access in a proximity of its respective network device.

The surveillance system may, for example, be set up within and/or near premises of an organization. The premises of the organization may be partitioned into multiple zones. One or more of the cameras may be coupled to one or more entrance and/or exit doors within one or more zones of the premises, for detecting when one or more users enter and/or exit these zones.

Moreover, the control arrangement may be operable to configure one or more of the cameras to detect motion, for example, based on their spatial location within the premises of the organization. These cameras may be configured to record activity and/or notify a system administrator when motion is detected.

Moreover, the cameras may be operable to record activity, and to stream recorded multimedia to the control arrangement on a real-time basis. Optionally, the recorded multimedia may be stored in a database that may be spatially remote from the surveillance system. Additionally or alternatively, the surveillance system may include a video recorder that may be operable to store the recorded multimedia. The video recorder may either be a part of the control arrangement or be a separate device coupled to the control arrangement.

Furthermore, each of the network devices may incorporate one or more physical connections to provide mechanical and/or electrical connections to one or more additional cameras. This may be desirable in cases where system administrators may want to install multiple cameras on a single network device, or may want to replace an existing camera with a camera having a higher resolution than the existing camera.

Examples of the network devices include, though are not limited to, wireless APs, modems, routers, network switches, network gateways and firewalls.

According to an embodiment of the present invention, various image analysis techniques, such as face-recognition techniques and object-recognition techniques, are employed to more accurately detect unauthorized access. One or more images or video frames captured by a camera may be analyzed to identify a user from his/her face, identify an object, identify a missing object, count a number of users, detect motion, and so on.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. Examples of the machine-readable storage medium may include, though are not limited to, fixed (hard) drives, magnetic tapes, floppy diskettes, optical disks, Compact Disc Read-Only Memories (CD-ROMs), magneto-optical disks, semiconductor memories, such as Read-Only Memories (ROMs), Random Access Memories (RAMs), Programmable ROMs (PROMs), Erasable PROMs (EPROMs), Electrically Erasable PROMs (EEPROMs), flash memories, magnetic or optical cards, or other type of media/machine-readable media suitable for storing electronic instructions (e.g., computer programming code, such as software or firmware). Moreover, embodiments of the present invention may also be downloaded as one or more computer program products, wherein the computer program products may be transferred from a remote computer to a requesting computer by way of data signals embodied in a carrier wave or other propagation medium via a communication link (e.g., a modem or a network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, a RAM, etc.) or by transmitting the code on a communication network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

### TERMINOLOGY

Brief definitions of terms used throughout this application are given below.

The phrase “network device” generally refers to a device that is used to facilitate communications among computers or other electronic devices within a communication network or between communications networks and/or communicatively couple such computers or other electronic devices together so that they can, among other things, share files or resources. A network device may receive data from an adjoining network device or a source, and may transmit the data to another adjoining network device or a destination. Examples of network devices include, but are not limited to, switches, hubs, routers, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

The phrase “wireless access point” generally refers to a network device that facilitates a wireless communication network to wireless devices, for example, using Wi-Fi, or related standards. A wireless Access Point (AP) may be connected to a router, if the wireless AP is a stand-alone device. Alternatively, the wireless AP may be a part of the router itself.

The phrase “network gateway” generally refers to a network device that joins two networks together. A “network gateway” can be implemented completely in hardware, or as a combination of hardware and software.

The term “camera” generally refers to a device that is capable of capturing images and/or video frames. The images may be still photographs, while the video frames may form a video. Images and/or video frames may be stored locally in an internal storage of a camera, transmitted to another device that is spatially remote from the camera, or both.

The term “control arrangement” generally refers to an application, program, process or device that controls functioning of network devices and/or cameras within a communication network.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phrases do not necessarily refer to the same embodiment.

If the specification states a component or feature “may”, “can”, “could”, or “might” be included or have a characteristic, that particular component or feature is not required to be included or have the characteristic.

The term “client” generally refers to an application, program, process or device in a client/server relationship that requests information or services from another program, process or device (a server) on a communication network. Importantly, the terms “client” and “server” are relative since an application may be a client to one application but a server to another. The term “client” also encompasses software that makes the connection between a requesting application, program, process or device to a server possible, such as an FTP client.

The term “server” generally refers to an application, program, process or device in a client/server relationship that responds to requests for information or services by another program, process or device (a server) on a communication network. The term “server” also encompasses software that makes the act of serving information or providing services possible.

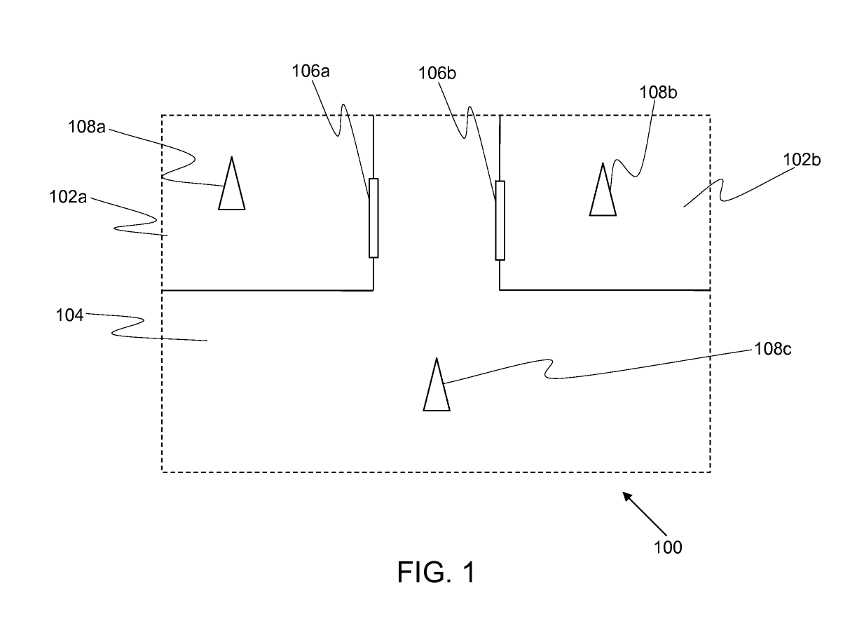

Referring now to the drawings, particularly by their reference numbers, FIG. 1 is an illustration of an example premises 100 in which a surveillance system may be employed pursuant to embodiments of the present invention. Example premises 100 is optionally partitioned into multiple zones. In the context of the present example, for illustration purposes, these zones are depicted as rooms 102a and 102b along a hallway 104. Users can enter and/or exit rooms 102a and 102b via one or more entrance and/or exit doors, depicted as doors 106a and 106b, respectively.

Example premises 100 is equipped with multiple network devices 108a, 108b and 108c included within the surveillance system. With reference to FIG. 1, room 102a has been equipped with network device 108a, room 102b has been equipped with network device 108b, and hallway 104 has been equipped with network device 108c.

Examples of network devices 108a-c include, though are not limited to, wireless APs, modems, routers, network switches, network gateways and firewalls.

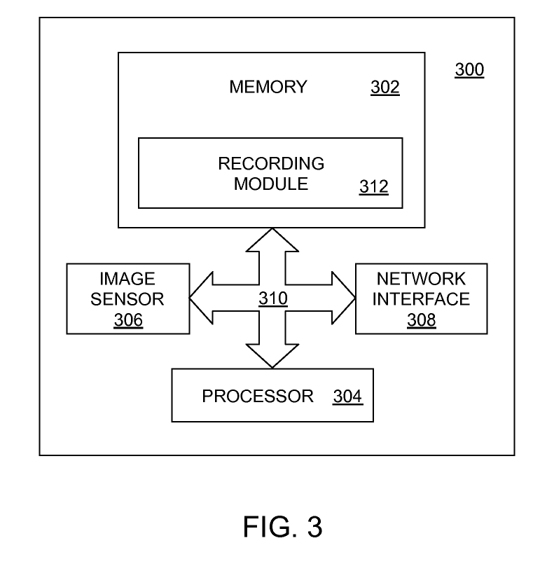

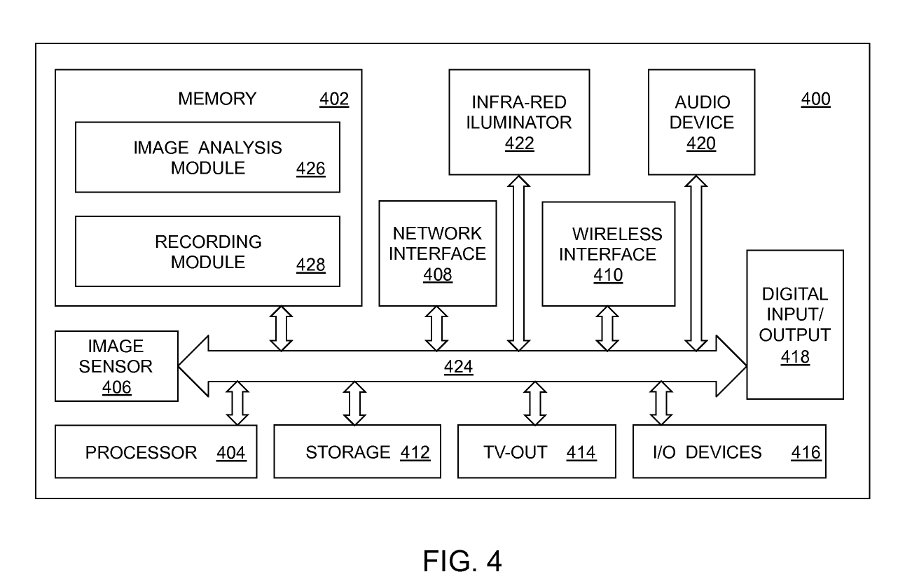

Network devices 108a-c include one or more cameras integrated therewith (not shown in FIG. 1). Network devices 108a-c are provided with software and/or hardware that enable the cameras to integrate with network devices 108a-c. Hence, separate power cables and Ethernet cables need not be provided to the cameras integrated with network devices 108a-c. This facilitates significant reduction in cost and time required to set up the surveillance system within and/or near example premises 100. Details of how a camera may be integrated with a network device are provided below in conjunction with FIG. 3 and FIG. 4.

Beneficially, the cameras may be cosmetically undetectable on surfaces of network devices 108a-c. Therefore, the cameras are less likely to be vandalized.

In order to detect when users enter and/or exit room 102a and/or room 102b, one or more of the cameras may be coupled to door 106a and/or door 106b, respectively. For example, one or more cameras integrated with network device 108a may be coupled to door 106a, for detecting when one or more users enter and/or exit room 102a. Similarly, one or more cameras integrated with network device 108b may be coupled to door 106b, for detecting when one or more users enter and/or exit room 102b. Details of how the cameras may be coupled to doors 106a and 106b is provided below in conjunction with FIG. 4.

In addition, the surveillance system includes a control arrangement (not shown in FIG. 1) coupled to network devices 108a-c and/or the cameras via a communication network. The control arrangement is operable to control the cameras to monitor activities of unauthorized users within and/or near example premises 100.

In accordance with an embodiment of the present invention, the control arrangement is operable to configure the cameras to track specific users connected to their respective network devices 108a-c. For example, the cameras may be operable to record routes taken by a specific user within example premises 100, and his/her activities enroute. In this manner, each camera may be made responsible for detecting unauthorized access/activity in proximity to its respective network device.

According to an embodiment of the present invention, various image analysis techniques, such as face-recognition techniques and object-recognition techniques, may be employed to more accurately detect unauthorized access. For example, one or more images or video frames captured by a camera may be analyzed to identify one or more users from their face, identify one or more objects, identify one or more missing objects, count a number of users, and so on.

Moreover, the cameras may be operable to record activity, and to stream recorded multimedia to the control arrangement on a real-time basis. The surveillance system may include a video recorder that may be operable to store the recorded multimedia streamed by the cameras. The video recorder may either be a part of the control arrangement or be a separate device coupled to the control arrangement. Additionally or alternatively, the recorded multimedia may be stored in a database that may be spatially remote from the surveillance system.

In accordance with an embodiment of the present invention, the control arrangement is operable to configure one or more of the cameras to detect motion, based on their spatial location within example premises 100. For illustration purposes, let us consider an example scenario in which room 102a may be a server room, which may be accessed at a certain time of a day. In such a case, the control arrangement may configure the cameras integrated with network device 108a to record activity and/or notify a system administrator when motion is detected.

For illustration purposes, let us also consider in the example scenario that the server room is permitted to be accessed by one or more authorized users only. In such a case, the control arrangement may configure the cameras to employ face-recognition techniques, and notify the system administrator when an unauthorized user accesses the server room. Additionally, the cameras may also employ other security measures, such as beeping an alarm, when a security threat is identified.

In accordance with an embodiment of the present invention, the control arrangement is operable to determine a spatial location of a rogue AP, and map the spatial location to at least one camera from amongst the cameras that is spatially located in proximity to the rogue AP. Subsequently, the control arrangement may then be operable to send a trigger request to the at least one camera to monitor activities of unauthorized users, who may be associated with the rogue AP.

### Detection of a Rogue AP:

A Wireless Intrusion Detection System (WIDS) may be employed in addition to the surveillance system. Alternatively, a WIDS may be employed as a part of the surveillance system itself. A WIDS may monitor a radio spectrum in use within and/or near example premises 100, to sense presence of wireless APs within and/or near example premises 100. For example, these wireless APs could include one or more APs authorized in the communication network and/or one or more APs used in a neighborhood network.

The WIDS may compare one or more attributes of the wireless APs with a pre-configured list of authorized APs to detect a rogue AP. For example, one or more attributes of a particular wireless AP may include at least one of: Media Access Control (MAC) address of that particular wireless AP, Service Set Identifier (SSID) of that particular wireless AP, unique signatures exhibited by signals originating from that particular wireless AP, and/or a name of a vendor of that particular wireless AP.

It may be noted here that wireless intrusion detection systems are well known in the art, and one of ordinary skill in the art would recognize many variations, alternatives and modifications of embodiments herein.

### Determination of Spatial Location of Rogue AP:

Once the presence of a rogue AP is detected, the surveillance system may determine the spatial location of the rogue AP. For this purpose, the control arrangement may employ various techniques, such as triangulation and trilateration. Such techniques involve using a set up of three of more wireless routers at suitable locations within example premises 100. These wireless routers are operable to communicate with the rogue AP using wireless signals, wherein Time-of-Flight (ToF) measurements and/or Received Signal Strength Indicator (RSSI) measurements of the wireless signals provide information about the relative distances between the rogue AP and the wireless routers. Based on the knowledge of locations of the wireless routers and the relative distances of the wireless routers from the rogue AP, the spatial location of the rogue AP may be determined.

Additionally or alternatively, the control arrangement may analyze entries of routing tables maintained by the wireless routers. A typical routing table may, for example, store information pertaining to various nodes in the communication network, for example, including spatial locations of these nodes and how these nodes can be reached. Based on the analysis of the routing tables, the control arrangement may determine a spatial location of a node that is being utilized by an Internet Protocol (IP) address of the rogue AP.

It may be noted here that triangulation, trilateration and routing tables are well known in the art, and one of ordinary skill in the art would recognize many variations, alternatives and modifications of embodiments herein.

### Mapping to a Nearest Camera:

The control arrangement may be operable to maintain a look-up table that includes information pertaining to network devices 108a-c and/or the cameras included within the surveillance system. For example, information pertaining to network device 108a may include at least one of: a unique identification code (ID) of network device 108a, a spatial location of network device 108a, a name of a vendor of network device 108a, a number of cameras integrated with network device 108a, and/or an IP address of a camera integrated with network device 108a. The unique ID may, for example, be MAC address, SSID, or other identification pertaining to network device 108a.

Similarly, information pertaining to a particular camera may include at least one of: a unique ID of that particular camera, an IP address of that particular camera, a spatial location of that particular camera, and/or an entrance and/or exit door to which that particular camera is coupled. It may be noted here that the spatial location of the particular camera may be taken as the spatial location of a network device with which that particular camera is integrated.

The control arrangement may then be operable to use the look-up table to determine individual distances between the rogue AP and the cameras. Subsequently, the control arrangement may be operable to compare the individual distances to identify one or more cameras that are spatially located proximate to the rogue AP. Thereafter, the control arrangement may send a trigger request to the identified cameras to monitor activities of unauthorized users, who may be associated with the rogue AP.

Subsequently, these cameras may be operable to record activity, and stream recorded multimedia to the control arrangement on a real-time basis. This may allow the system administrator to view the recorded multimedia in real-time. This may help the system administrator determine whether an unauthorized access has been made to the communication network and/or determine the severity of the threat from the unauthorized access. In this manner, various components of the surveillance system are capable of functioning synergistically to detect unauthorized access.

Moreover, the control arrangement may also be operable to maintain a log of rogue APs detected by the WIDS and/or the surveillance system. The log may, for example, include information about the spatial location of the rogue APs along with associated time stamps. The control arrangement may be operable to analyze the log to identify specific spatial locations within and/or near example premises 100 that are prone to security threats. This may help the system administrators in taking appropriate actions to prevent unauthorized access to the communication network.

Furthermore, each of network devices 108a-c may incorporate one or more physical connections to provide mechanical and/or electrical connections to one or more additional cameras. This may be desirable in cases where the system administrator may want to install multiple cameras on a single network device, or may want to replace an existing camera with a camera having a higher resolution than the existing camera. Multiple cameras on a single network device may be utilized to look all around a zone, or monitor different areas of the zone simultaneously.

Moreover, the cameras may use various types of lenses, based on mounting location and/or mounting angle of network devices 108a-c. In one example, a wall-mounted network device may have a camera near a bottom edge of the wall-mounted network device. In such a case, the camera may use a wide-angle lens that is capable of looking down and towards both sides. In another example, a ceiling-mounted network device may have a camera on a bottom face of the ceiling-mounted network device. In such a case, the camera may use a fisheye lens that is capable of providing an aerial view.

Moreover, a Pan-Tilt-Zoom (PTZ) camera could be used to look around a room, and zoom-in or zoom-out. The PTZ camera may be controlled from a remote location.

It should be noted here that example premises 100 is not limited to a specific number of rooms, doors, network devices and cameras. FIG. 1 is merely an example, which should not unduly limit the scope of the claims herein. One of ordinary skill in the art will appreciate many variations, alternatives, and modifications of embodiments herein. For example, multiple network devices with integrated cameras may be installed, so as to cover a large area. Beneficially, these network devices may be spatially dispersed within and/or near premises of an organization, so as to provide a broad coverage.

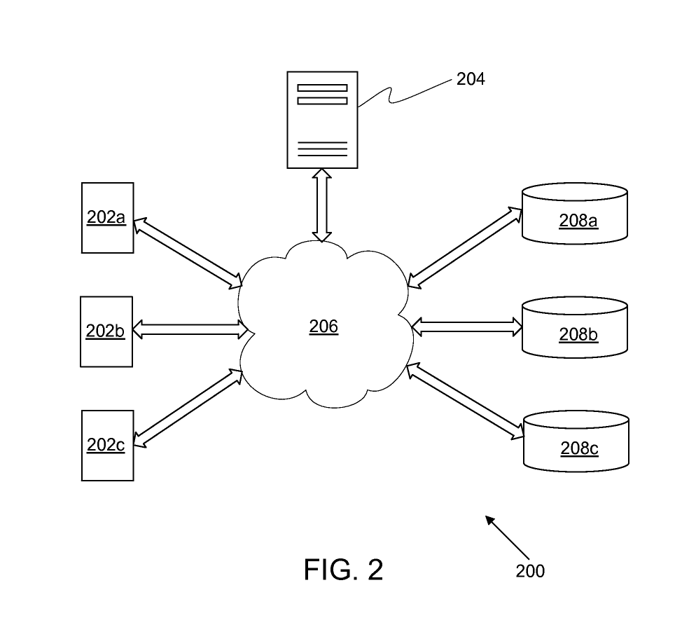

FIG. 2 is a block diagram conceptually illustrating a network environment 200 in which a surveillance system may be implemented in accordance with an embodiment of the present invention. In the context of the present example, the network environment 200 includes one or more network devices 202a-c, a control arrangement 204, a communication network 206, and one or more databases 208a-c.

Network devices 202a-c include one or more cameras integrated therewith (not shown in FIG. 2). Network devices 202a-c are provided with software and/or hardware that enable the cameras to integrate with network devices 202a-c. Details of how a camera may be integrated with a network device are been provided below in conjunction with FIG. 3 and FIG. 4.

Examples of network devices 202a-c include, though are not limited to, wireless APs, modems, routers, network switches, network gateways and firewalls.

Beneficially, the cameras may be cosmetically undetectable on surfaces of network devices 202a-c. Therefore, the cameras are less likely to be vandalized.

Moreover, each of network devices 202a-c may incorporate one or more physical connections to provide mechanical and/or electrical connections to one or more additional cameras. This may be desirable in cases where a system administrator may want to install multiple cameras on a single network device, or may want to replace an existing camera with a camera having a higher resolution than the existing camera.

The cameras along with network devices 202a-c and control arrangement 204 form a part of the surveillance system. The surveillance system may be implemented within and/or near premises of an organization.

Moreover, communication network 206 can be a collection of individual networks, interconnected with each other and functioning as a single large network. Such individual networks may be wired, wireless, or a combination thereof. Examples of such individual networks include, though are not limited to, Local Area Networks (LANs), Wide Area Networks (WANs), Metropolitan Area Networks (MANs), Wireless LANs (WLANs), Wireless WANs (WWANs), and Wireless MANs (WMANs). WLANs are typically based on IEEE 802.11 standards, and are marketed under the brand name “Wi-Fi”.

Communication network 206 couples network devices 202a-c to control arrangement 204, and control arrangement 204 to databases 208a-c. For example, the cameras integrated with network devices 202a-c may be operable to stream recorded multimedia to control arrangement 204 over a LAN employed within the organization.

Furthermore, control arrangement 204 may be operable to store the recorded multimedia in at least one of databases 208a-c. The recorded multimedia may then be accessed from the at least one of databases 208a-c, as and when required.

Optionally, the at least one of databases 208a-c may be located spatially remote from the surveillance system. For example, the at least one of databases 208a-c may be implemented via cloud computing services. In such a case, control arrangement 204 may be coupled to the at least one of databases 208a-c via a WAN.

It should be noted here that the implementation of the network environment 200 is not limited to a specific type or number of network devices, cameras, control arrangements, databases and communication networks. FIG. 2 is merely an example, which should not unduly limit the scope of the claims herein. One of ordinary skill in the art would recognize many variations, alternatives, and modifications of embodiments herein.

FIG. 3 is a block diagram conceptually illustrating interaction among various functional units of a camera 300, in accordance with an embodiment of the present invention. Camera 300 may be integrated with a network device, which could be implemented in a manner that is similar to the implementation of network devices 108a-c or network devices 202a-c. Examples of the network device include, though are not limited to, a wireless AP, a modem, a router, a network switch, a network gateway and a firewall.

Camera 300 includes, but is not limited to, a memory 302, a processor 304, an image sensor 306, a network interface 308, and a system bus 310 that operatively couples various functional units including memory 302, processor 304, image sensor 306 and network interface 308. Memory 302 stores a recording module 312.

The network device with which camera 300 is integrated facilitates supply of electrical power to various functional units of camera 300. In one example, camera 300 may be connected to the network device via a Universal Serial Bus (USB). In such a case, the USB may facilitate supply of electrical power along with data communication to camera 300.

In another example, camera 300 may be an IP camera that supports Power over Ethernet (POE) protocol for electrical power supply. The POE allows a single Ethernet cable to provide data communication as well as electrical power to camera 300. Accordingly, camera 300 may conform to IEEE 802.3Af or IEEE 802.3At standards for POE protocol.

It may be noted here that the POE is facilitated by the network device to camera 300 via network interface 308. As the POE is facilitated by the network device with which camera 300 is integrated, separate power and Ethernet cables need not be provided to camera 300. This facilitates significant reduction in cost and time required to set up camera 300 within premises of an organization.

Within a communication network, camera 300 may be assigned its initial IP address by a Dynamic Host Configuration Protocol (DHCP) server. Once camera 300 has been assigned an IP address, camera 300 can be discovered, for example, using multicast Domain Name System (mDNS) protocol within the communication network. Camera 300 may then be configured via an Application Programming Interface (API) defined to use HyperText Transfer Protocol (HTTP) as a transport protocol. Such an API may, for example, be provided by the network device via network interface 308. Hence, network interface 308 may be used to upload new configuration and/or software updates to camera 300.

Furthermore, image sensor 306 may be operable to convert an optical image into a digital representation of the image. Examples of image sensor 306 may include, though are not limited to, Charge-Coupled Device (CCD) sensors and Complementary Metal-Oxide-Semiconductor (CMOS) sensors.

Beneficially, image sensor 306 may be interfaced with recording module 312. This may enable processor 304 to control functioning of image sensor 306.

When executed on processor 304, recording module 312 is operable to record multiple images and/or video frames captured by image sensor 306. For example, multiple video frames may be combined together to generate a video clip. The video clip may, for example, be generated to record motion events. The size of the video clip may be limited by a size of memory 302 or a buffer used by camera 300. It may be noted here that memory 302 may include run-time memory and flash memory.

Camera 300 may be configured to upload the recorded video clip to a server that is spatially remote from camera 300. The video clip may be uploaded, for example, using File Transfer Protocol (FTP) or Server Message Block (SMB) protocol. The SMB protocol is also known as Common Internet File System (CIFS) protocol.

Additionally or alternatively, camera 300 may be configured to stream recorded multimedia, including images and/or videos, to a control arrangement (similar to control arrangement 204) via network interface 308. Camera 300 may stream the recorded multimedia, for example, upon receiving a trigger request from the control arrangement. For example, the trigger request may be processed by processor 304 to identify an IP address associated with the control arrangement. Consequently, the recorded multimedia may be streamed to the IP address associated with the control arrangement.

For example, a Network Video Recorder (NVR) may discover camera 300 using mDNS protocol and the like. Upon discovery, the NVR may configure camera 300 to stream the recorded multimedia to the NVR. It may be noted here that the NVR may either be a part of the control arrangement or be a separate device coupled to the control arrangement.

Beneficially, camera 300 may be configured to stream the recorded multimedia on a real-time basis. Accordingly, the recorded multimedia may be streamed, for example, using Real Time Streaming Protocol (RTSP) or other proprietary streaming protocols. RTSP typically uses Real-time Transport Protocol (RTP) in conjunction with Real-time Control Protocol (RTCP) for multimedia streaming.

As described earlier, the control arrangement may then be operable to store the recorded multimedia in a database that may be spatially remote from the control arrangement and/or camera 300.

Moreover, camera 300 may be provided with an Uninterruptible Power Supply (UPS) to allow images and/or videos to be captured, even when the electrical power supply is turned off

Moreover, the network device may be operable to provide a functionality of encoding the recorded multimedia as per a suitable compression format. The compression format may, for example, be either lossless or lossy. For example, Advanced Video Coding (AVC) or H.264/MPEG-4 Part 10 is a well-known standard for video compression. Video compression may reduce storage requirements during storing, and may also reduce communicational load during uploading or streaming.

FIG. 3 is merely an example, which should not unduly limit the scope of the claims herein. It is to be understood that the specific designation for camera 300 is for the convenience of reader and is not to be construed as limiting camera 300 to specific numbers, types, or arrangements of modules and/or functional units of camera 300. One of ordinary skill in the art would recognize many variations, alternatives, and modifications of embodiments of the present invention.

It may be noted here that one or more of the functional units of camera 300 may be facilitated by the network device with which camera 300 is integrated. For example, the network device may provide memory 302, processor 304 and/or network interface 308 to camera 300. Consider, for example, that the network device is implemented as a network gateway spatially located in a server room. In such a case, the network device may be capable of providing computational space and processing power for motion detection and other image analysis.

Beneficially, camera 300 may be cosmetically undetectable on the surface of the network device. Therefore, camera 300 is less likely to be vandalized.

Moreover, camera 300 may be an indoor camera or an outdoor camera, based on a spatial location where the network device has been set up.

Moreover, camera 300 may use various types of lens, based on mounting location and/or mounting angle of the network device with which camera 300 is integrated. In one example, the network device may be a wall-mounted network device, and camera 300 may be positioned near a bottom edge of the network device. In such a case, camera 300 may use a wide-angle lens that is capable of looking down and to the sides. In another example, the network device may be a ceiling-mounted network device, and camera 300 may be positioned on a bottom face of the network device. In such a case, camera 300 may use a fisheye lens that is capable of providing an aerial view.

Moreover, camera 300 may be provided with a PTZ control, which could be used to pan and/or tilt camera 300, for example, to look around a zone, and/or be used to zoom-in or zoom-out a view. The PTZ control may be operated from a remote location.

Furthermore, one or more additional cameras may be installed and integrated on the network device, as and when required. For this purpose, the network device may incorporate one or more physical connections to provide mechanical and/or electrical connections to these additional cameras. The additional cameras may be implemented in a manner that is similar to the implementation of camera 300.

FIG. 4 is a block diagram conceptually illustrating interaction among various functional units of a camera 400, in accordance with an embodiment of the present invention. Camera 400 may be integrated with a network device, which could be implemented in a manner that is similar to the implementation of network devices 108a-c or network devices 202a-c. Examples of the network device include, though are not limited to, a wireless AP, a modem, a router, a network switch, a network gateway and a firewall.

Camera 400 includes, but is not limited to, a memory 402, a processor 404, an image sensor 406, a network interface 408, a wireless interface 410, a storage 412, a TeleVision (TV) out 414, Input/Output (I/O) devices 416, one or more digital I/O 418, an audio device 420, an infra-red illuminator 422, and a system bus 424 that operatively couples various functional units of camera 400. Memory 402 stores an image analysis module 426 and a recording module 428.

The network device with which camera 400 is integrated facilitates supply of electrical power to various functional units of camera 400. In one example, camera 400 may be connected to the network device via a USB. In such a case, the USB may facilitate supply of electrical power along with data communication to camera 400.

In another example, camera 400 may be an IP camera that supports POE protocol for electrical power supply. The POE allows a single Ethernet cable to provide data communication as well as electrical power to camera 400. Accordingly, camera 400 may conform to IEEE 802.3Af or IEEE 802.3At standards for POE protocol.

It may be noted here that the POE is facilitated by the network device to camera 400 via network interface 408. As the POE is facilitated by the network device with which camera 400 is integrated, separate power and Ethernet cables need not be provided to camera 400. This facilitates significant reduction in cost and time required to set up camera 400 within premises of an organization.

Within a communication network, camera 400 may be assigned its initial IP address by a DHCP server. Once camera 400 has been assigned an IP address, camera 400 can be discovered, for example, using mDNS protocol within the communication network. Camera 400 may then be configured via an API defined to use HTTP as a transport protocol. Such an API may, for example, be provided by the network device via network interface 408. Hence, network interface 408 may be used to upload new configuration and/or software updates to camera 400.

While network interface 408 may facilitate wired communication, wireless interface 410 may facilitate wireless communication. Wireless interface 410 may, for example, employ Wi-Fi, third generation (3G) telecommunication, fourth generation (4G) telecommunication, or Worldwide Interoperability for Microwave Access (WiMAX).

Furthermore, image sensor 406 may be operable to convert an optical image into a digital representation of the image. Examples of image sensor 406 may include, though are not limited to, CCD sensors and CMOS sensors.

Beneficially, image sensor 406 may be interfaced with image analysis module 426 and/or recording module 428. This may enable processor 404 to control functioning of image sensor 406. Apart from image sensor 406, processor 404 may control functioning of other functional units of camera 400 as well.

When executed on processor 404, image analysis module 426 is operable to resolve outputs generated by image sensor 406 into multiple images and/or video frames, and analyze the images and/or video frames. Image analysis module 426 may be operable to employ image analysis techniques, such as face-recognition techniques and object-recognition techniques. Image analysis module 426 may be operable to analyze the images and/or video frames to perform at least one of following tasks of:

(a) identifying a user from his/her face,
(b) identifying an object,
(c) identifying a missing object,
(d) counting a number of users, and/or
(e) detecting motion.

When executed on processor 404, recording module 428 is operable to record the images and/or video frames captured by image sensor 406. For example, multiple video frames may be combined together to generate a video clip. The video clip may, for example, be generated to record motion events.

Camera 400 may be configured to store the video clip in storage 412. Hence, the size of the video clip may be limited by a size of storage 412. Storage 412 may, for example, be a Secure Digital (SD) card, a miniSD card, or a microSD card. In absence of storage 412, the size of the video clip may be limited by a size of memory 402 or a buffer used by camera 400.

Camera 400 may be configured to upload the recorded video clip to a server that is spatially remote from camera 400. The video clip may be uploaded, for example, using FTP or SMB protocol.

Additionally or alternatively, camera 400 may be configured to stream recorded multimedia, including images and/or videos, to a control arrangement (similar to control arrangement 204) via network interface 408. Camera 400 may stream the recorded multimedia, for example, upon receiving a trigger request from the control arrangement. For example, the trigger request may be processed by processor 404 to identify an IP address associated with the control arrangement. Consequently, the recorded multimedia may be streamed to the IP address associated with the control arrangement.

For example, an NVR may discover camera 400 using mDNS protocol and the like. Upon discovery, the NVR may configure camera 400 to stream the recorded multimedia to the NVR. It may be noted here that the NVR may either be a part of the control arrangement or be a separate device coupled to the control arrangement.

Beneficially, camera 400 may be configured to stream the recorded multimedia on a real-time basis. Accordingly, the recorded multimedia may be streamed, for example, using RTSP or other proprietary streaming protocols. As described earlier, the control arrangement may then be operable to store the recorded multimedia in a database that may be spatially remote from the control arrangement and/or camera 400.

Furthermore, TV-out 414 may be a port on camera 400 that may provide an analog video signal corresponding to the recorded multimedia. TV-out 414 may be connected to an input port of a display device, such as a TV and a monitor, using a suitable connecting cable.

Digital I/O 418 may include multiple ports that may be used to connect camera 400 to one or more external devices. In one example, an external device, such as a latch module or a card-swipe module of a door, may be connected to camera 400 via a digital-input connector. The external device may send an input signal to camera 400, when a user enters or exits from the door. Upon receiving the input signal, camera 400 may record activity and generate a corresponding video clip.

In another example, an external device may be connected to camera 400 via a digital-output connector. In such a case, camera 400 may send an output signal to the external device, for example, when motion or other malicious activity is detected. The external device may be a security alarm, which may beep and alert a system administrator or security personnel, upon receiving the output signal. Alternatively, the external device may be a light source that may turn on or off to alert the system administrator or the security personnel, upon receiving the output signal.

Moreover, audio device 420 may include a speaker that may be used, for example, to make general security announcements to users or to alert the system administrator or the security personnel.

Alternatively, audio device 420 may include a microphone that may be used to provide one or more voice commands to camera 400 or to communicate an audio signal to another device or the system administrator.

Moreover, infra-red illuminator 422 may add an extra security measure to camera 400 by facilitating visibility under low-light conditions. Consequently, camera 400 may be capable of recording activity even under low-light conditions.

Beneficially, infra-red illuminator 422 may be interfaced with image analysis module 426. This may enable processor 404 to control functioning of infra-red illuminator 422, based on image analysis performed by image analysis module 426. For example, processor 404 may turn on infra-red illuminator 422 when image analysis module 426 detects low-light conditions.

Additionally, camera 400 may be provided with a UPS to allow images and/or videos to be captured, even when the electrical power supply is turned off.

Furthermore, the network device may be operable to provide a functionality of encoding the recorded multimedia as per a suitable compression format, such as AVC. The compression format may, for example, be either lossless or lossy. Multimedia compression may reduce storage requirements during storing, and may also reduce communicational load during uploading or streaming.

FIG. 4 is merely an example, which should not unduly limit the scope of the claims herein. It is to be understood that the specific designation for camera 400 is for the convenience of reader and is not to be construed as limiting camera 400 to specific numbers, types, or arrangements of modules and/or functional units of camera 400. One of ordinary skill in the art would recognize many variations, alternatives, and modifications of embodiments of the present invention.

It may be noted here that one or more of the functional units of camera 400 may be facilitated by the network device with which camera 400 is integrated. For example, the network device may provide memory 402, processor 404, network interface 408, wireless interface 410 and/or storage 412 to camera 400. Consider, for example, that the network device is implemented as a network gateway spatially located in a server room. In such a case, the network device may be capable of providing computational space and processing power for motion detection and other image analysis.

Beneficially, camera 400 may be cosmetically undetectable on the surface of the network device. Therefore, camera 400 is less likely to be vandalized.

Moreover, camera 400 may be an indoor camera or an outdoor camera, based on a spatial location where the network device has been set up.

Moreover, camera 400 may use various types of lens, based on mounting location and/or mounting angle of the network device with which camera 400 is integrated. In one example, the network device may be a wall-mounted network device, and camera 400 may be positioned near a bottom edge of the network device. In such a case, camera 400 may use a wide-angle lens that is capable of looking down and towards sides. In another example, the network device may be a ceiling-mounted network device, and camera 400 may be positioned on a bottom face of the network device. In such a case, camera 400 may use a fisheye lens that is capable of providing an aerial view.

Moreover, camera 400 may be provided with a PTZ control, which could be used to pan and/or tilt camera 400, for example, to look around a zone, and/or be used to zoom-in or zoom-out a view. The PTZ control may be operated from a remote location.

Furthermore, one or more additional cameras may be installed and integrated on the network device, as and when required. For this purpose, the network device may incorporate one or more physical connections to provide mechanical and/or electrical connections to these additional cameras. The additional cameras may be implemented in a manner that is similar to the implementation of camera 400.

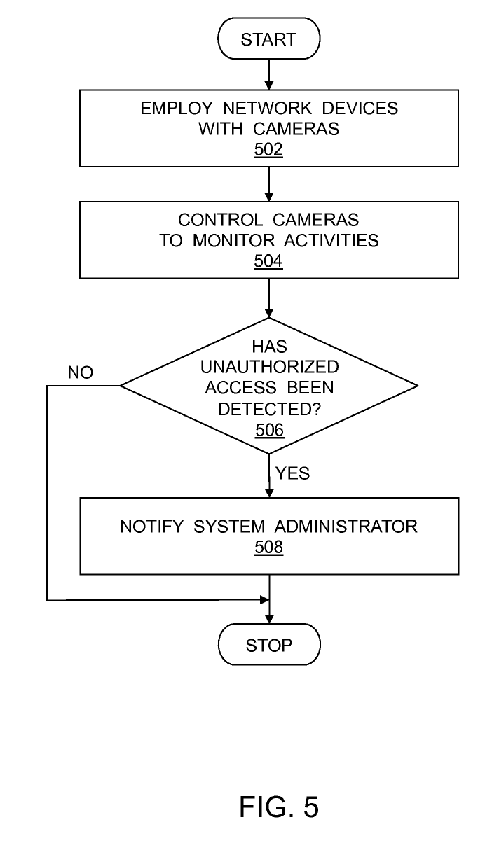

FIG. 5 is a flow diagram illustrating unauthorized access detection processing in accordance with an embodiment of the present invention. The flow diagram is depicted as a collection of steps in a logical flow, which represents a sequence of steps that can be implemented in hardware, software, or a combination thereof.

At step 502, one or more network devices including one or more cameras integrated therewith are employed within a communication network. The network devices are provided with software and/or hardware that enables the network devices to integrate with the cameras, as described earlier.

At step 504, the cameras are controlled to monitor activities of unauthorized users. Step 504 may be performed by a control arrangement (similar to control arrangement 204) coupled to the network devices and/or the cameras via the communication network.

Next, at step 506, it is checked whether or not unauthorized access has been detected.

In accordance with step 506, one or more of the cameras may be configured to track specific users connected to their respective network devices, to detect unauthorized access. Accordingly, these cameras may employ various image analysis techniques, such as face-recognition techniques and object-recognition techniques, to identify one or more users, one or more missing objects, and so on.

Additionally or alternatively, one or more of the cameras may be configured to detect motion, based on their spatial location. Accordingly, these cameras may employ various motion-detection techniques to detect motion.

If, at step 506, it is found that unauthorized access has been detected, step 508 is performed. At step 508, a system administrator is notified, meanwhile the cameras record suspicious activity and/or stream recorded multimedia to the control arrangement.

It should be noted here that the steps 502 to 508 are only illustrative and other alternatives can also be provided where one or more steps are added, one or more steps are removed, or one or more steps are provided in a different sequence without departing from the scope of the claims herein.

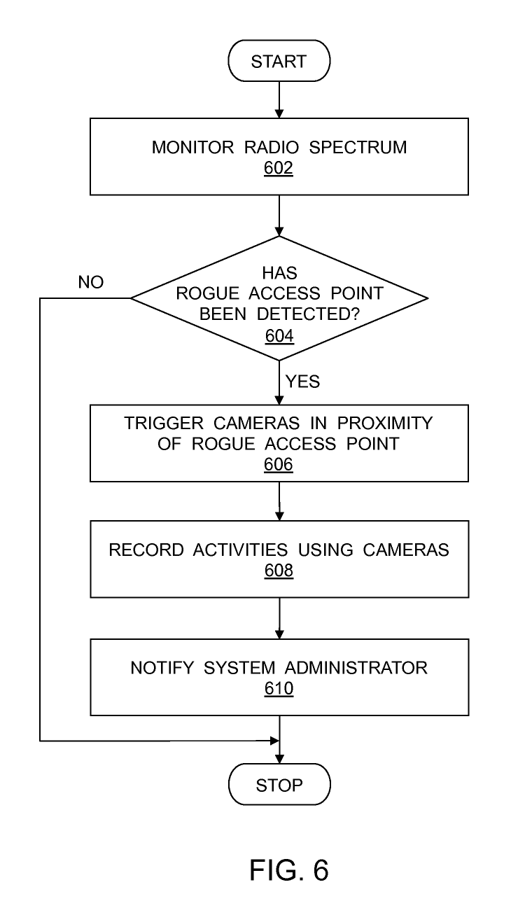

FIG. 6 is a flow diagram illustrating intrusion detection processing, in accordance with an embodiment of the present invention. The flow diagram is depicted as a collection of steps in a logical flow, which represents a sequence of steps that can be implemented in hardware, software, or a combination thereof.

The intrusion detection processing relates to detection of rogue APs within and/or near premises of an organization, for illustration purposes only. It may be noted here that a rogue AP may be detected within and/or near any premises, where a surveillance system has been employed pursuant to embodiments of the present invention.

At step 602, a radio spectrum in use within and/or near the premises is monitored. Step 602 may, for example, be performed by a WIDS that may be employed in addition to or as a part of the surveillance system, as described earlier.

At step 604, it is checked whether or not a rogue AP has been detected. If, at step 604, it is found that a rogue AP has been detected, a step 606 is performed.

At step 606, one or more cameras, integrated with one or more network devices, spatially located in a proximity of the rogue AP are triggered to monitor activities of unauthorized users.

Step 606 may include multiple sub-steps, as described earlier. At a first sub-step, a spatial location of the rogue AP may be determined, for example, by way of triangulation or trilateration. At a second sub-step, one or more cameras integrated with one or more network devices may be mapped to the spatial location of the rogue AP, such that the cameras are spatially located in a proximity of the rogue AP. Next, at a third sub-step, these cameras are sent a trigger request to monitor activities of the unauthorized users, who may be associated with the rogue AP.

Subsequently, at a step 608, the cameras record activities of the unauthorized users, upon receiving the trigger request at step 606. In accordance with step 608, the cameras may stream recorded multimedia to a control arrangement, included with the surveillance system, on a real-time basis.

Meanwhile, at a step 610, a system administrator is notified.

It should be noted here that the steps 602 to 610 are only illustrative and other alternatives can also be provided where one or more steps are added, one or more steps are removed, or one or more steps are provided in a different sequence without departing from the scope of the claims herein.

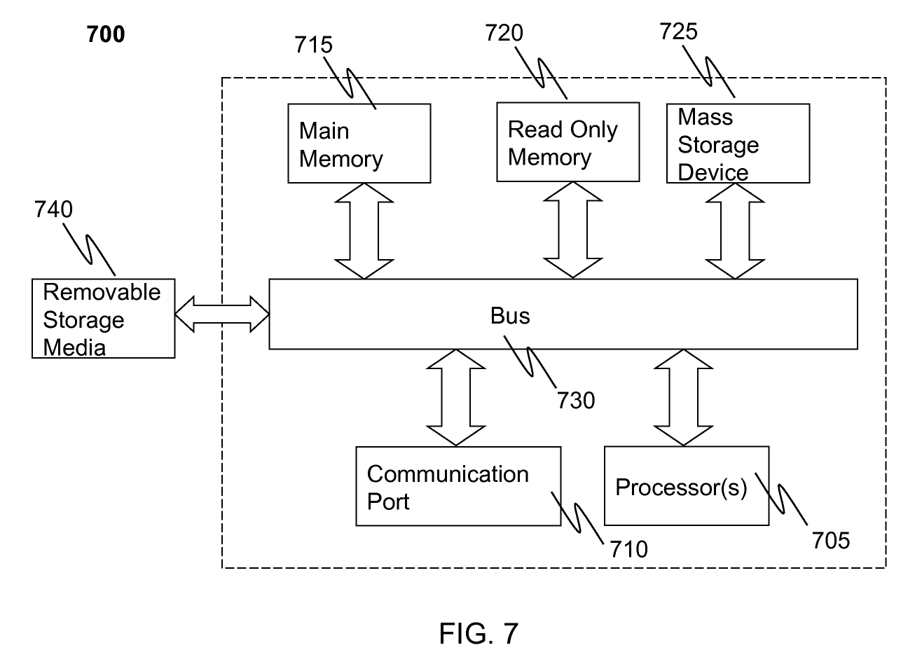

FIG. 7 is an example of a computer system 700 with which embodiments of the present disclosure may be utilized. Computer system 700 may represent or form a part of a control arrangement (e.g., control arrangement 204), a surveillance system, a WIDS, a network device (e.g., network devices 108a-c or 202a-c), a camera (e.g., camera 300 or 400), a server or an end user or administrator workstation.

Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 700 includes a bus 730, a processor 705, communication port 710, a main memory 715, a removable storage media 740, a read only memory 720 and a mass storage 725. A person skilled in the art will appreciate that computer system 700 may include more than one processor and communication ports.

Examples of processor 705 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 705 may include various modules associated with monitoring unit as described in FIGS. 1-5.

Communication port 710 can be any of an RS-232 port for use with a modem based dialup connection, a 10/100 Ethernet port, a Gigabit or 10 Gigabit port using copper or fiber, a serial port, a parallel port, or other existing or future ports. Communication port 710 may be chosen depending on a network, such a Local Area Network (LAN), Wide Area Network (WAN), or any network to which computer system 700 connects.

Memory 715 can be Random Access Memory (RAM), or any other dynamic storage device commonly known in the art. Read only memory 720 can be any static storage device(s) such as, but not limited to, a Programmable Read Only Memory (PROM) chips for storing static information such as start-up or BIOS instructions for processor 705.

Mass storage 725 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 730 communicatively couples processor(s) 705 with the other memory, storage and communication blocks. Bus 730 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 705 to system memory.

Optionally, operator and administrative interfaces, such as a display, keyboard, and a cursor control device, may also be coupled to bus 730 to support direct operator interaction with computer system 700. Other operator and administrative interfaces can be provided through network connections connected through communication port 710.

Removable storage media 740 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the present disclosure.

While embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

What is claimed is:

1. A surveillance system comprising:
one or more network devices including one or more cameras integrated therewith, wherein the one or more network devices are provided with software and hardware that enables the one or more network devices to integrate with the one or more cameras; and
a control arrangement coupled to the one or more network devices via a communication network, wherein the control arrangement is operable to control the one or more cameras to monitor activities of unauthorized users.

2. The surveillance system of claim 1, wherein the control arrangement is operable to determine a spatial location of a rogue Access Point (AP) and map the spatial location to at least one camera from amongst the one or more cameras spatially located in proximity to the rogue AP.

3. The surveillance system of claim 2, wherein the control arrangement is operable to send a trigger request to the at least one camera to monitor activities of unauthorized users.

4. The surveillance system of claim 2, wherein the spatial location of the rogue AP is determined by way of triangulation.

5. The surveillance system of claim 1, wherein the control arrangement is operable to configure the one or more cameras to track specific users connected to their respective network devices.

6. The surveillance system of claim 1, wherein the one or more cameras are coupled to one or more entrance or exit doors within one or more zones to facilitate detecting when one or more users enter or exit the one or more zones.

7. The surveillance system of claim 1, wherein the control arrangement is operable to configure the one or more cameras to detect motion, and to record activity and/or notify a system administrator when motion is detected.

8. The surveillance system of claim 1, wherein the one or more cameras are operable to record activity and to stream recorded multimedia to the control arrangement on a real-time basis.

9. The surveillance system of claim 8, wherein the recorded multimedia is stored in a database that is spatially remote from the surveillance system.

10. The surveillance system of claim 8 further comprising a video recorder for storing the recorded multimedia.

11. The surveillance system of claim 1, wherein the one or more network devices comprise one or more wireless Access Points (APs).

12. The surveillance system of claim 1, wherein the one or more network devices comprise one or more routers or one or more network gateways.

13. The surveillance system of claim 1, wherein the one or more cameras are cosmetically undetectable on surfaces of the one or more network devices.

14. The surveillance system of claim 1, wherein each of the one or more network devices incorporates one or more physical connections to provide mechanical or electrical connections to one or more additional cameras.

15. A method for detecting unauthorized access, the method comprising:
employing one or more network devices comprising one or more cameras integrated therewith, wherein the one or more network devices are provided with software and hardware that enables the one or more network devices to integrate with the one or more cameras; and
controlling the one or more cameras to monitor activities of unauthorized users via a control arrangement, wherein the control arrangement is coupled to the one or more network devices via a communication network.

16. The method of claim 15, further comprising:
determining a spatial location of a rogue Access Point (AP); and
mapping the spatial location to at least one camera from amongst the one or more cameras spatially located proximate to the rogue AP.

17. The method of claim 16, further comprising sending a trigger request to the at least one camera to monitor activities of unauthorized users.

18. The method of claim 16, wherein the spatial location of the rogue AP is determined by way of triangulation.

19. The method of claim 15, further comprising configuring the one or more cameras to track specific users connected to their respective network devices.

20. The method of claim 15, further comprising:
coupling the one or more cameras to one or more entrance or exit doors within one or more zones; and
detecting when one or more users enter or exit the one or more zones.

21. The method of claim 15 further comprising:
configuring the one or more cameras to detect motion; and
recording activity or notifying a system administrator when motion is detected.

22. The method of claim 15, further comprising streaming recorded multimedia from the one or more cameras to the control arrangement on a real-time basis.

23. The method of claim 22, further comprising storing the recorded multimedia in a database that is spatially remote from the control arrangement and the one or more cameras.

24. The method of claim 15, wherein the one or more network devices comprise one or more wireless Access Points (APs).

25. The method of claim 15, wherein the one or more network devices comprise one or more routers or one or more network gateways.

26. The method of claim 15, wherein the one or more cameras are cosmetically undetectable on surfaces of the one or more network devices.

27. The method of claim 15, wherein each of the one or more network devices incorporates one or more physical connections to provide mechanical or electrical connections to one or more additional cameras.
